(19) United States
(12) Patent Application Publication
(10) Pub. No.: US 2026/0122193 A1
(43) Pub. Date: Apr. 30, 2026

(54) IMAGE READING APPARATUS AND IMAGE FORMING SYSTEM

(71) Applicant: CANON KABUSHIKI KAISHA, Tokyo (JP)

(72) Inventor: SHOJI TANAKA, Chiba (JP)

(21) Appl. No.: 19/364,251

(22) Filed: Oct. 21, 2025

(30) Foreign Application Priority Data
Oct. 25, 2024 (JP) 2024-188267

(51) Int. Cl. H04N 1/10; B41J 11/00; H04N 1/00; H04N 1/40

(52) U.S. Cl. CPC H04N 1/1065; B41J 11/007; B41J 11/0085; H04N 1/00607; H04N 1/0061; H04N 1/40087

(57) ABSTRACT

An image reading apparatus includes a conveyance portion configured to convey a sheet on which an image has been formed, a reading unit configured to read the image formed on the sheet being conveyed by the conveyance portion, a transparent member provided between the reading unit and a position at which the conveyance portion conveys the sheet, a reference member, which is provided to the transparent member, and is to be read by the reading unit, support members configured to support the transparent member at both ends in a direction intersecting a conveyance direction of the sheet being conveyed by the conveyance portion, and a moving portion configured to move the support members.

### BACKGROUND

### Field of the Technology

The present disclosure relates to an image reading apparatus for reading an image formed on a sheet and an image forming system including such an image reading apparatus.

### Description of the Related Art

A market for printing machines is expanding in a commercial printing field and an industrial printing field. Printing methods used by printing machines (image forming systems) in such fields include an electrophotographic method, which is spreading also into an offset printing market, and an inkjet method, which has successfully developed a wide-range market with its large format, low initial cost, and ultra-high speed, for example.

Examples of an inkjet printing machine include a line head type recording apparatus in which a recording head fixed to a main body ejects liquid droplets in conjunction with a sheet being conveyed, to thereby print an image on the sheet. When the line head type recording apparatus is used in the commercial printing field and the industrial printing field in each of which image quality is required, an image reading apparatus is provided on a downstream side of the recording head in a conveyance direction of the sheet.

The image reading apparatus reads the image formed on the sheet. A reading result obtained by the image reading apparatus is used to, for example, detect a defect of ejection of liquid droplets by the recording head, correct color misregistration, adjust image density unevenness, and adjust geometric characteristics of the image to be printed. Here, the geometric characteristics of the image refer to a shape, a position, and the like of the image.

The image reading apparatus includes an image sensor including a light source and a photoelectric conversion element. The image reading apparatus receives, through use of the photoelectric conversion element, light reflected from the sheet irradiated with light from the light source, and outputs the received light as a reading result. In order to acquire stable reading results, the image reading apparatus performs shading correction for correcting variation in the light amount distribution of the light emitted from the light source and individual differences among respective photoelectric conversion elements. The image reading apparatus reads a white reference plate that serves as a white reference at the time of shading correction.

It is preferred that a distance between the image sensor and the white reference plate exhibited in a case where the white reference plate is read at the time of the shading correction match a distance between the image sensor and the sheet exhibited in a case where the image on the sheet is read. In a case where those distances are different, the shading correction is not performed with high accuracy, and hence it becomes difficult to perform image correction with high accuracy. In Japanese Patent Application Laid-open No. 2015-76748, in a case where the shading correction is to be performed, the white reference plate is moved to a position between the image sensor and a placement surface on which a sheet to be read is placed.

However, the image sensor used in the image reading apparatus generates a measurement error due to a difference between a first distance to the white reference plate and a second distance to a surface of the sheet. Therefore, it is preferred to cause the first distance and the second distance to match to suppress the measurement error. Further, the image sensor is provided with a transparent member (reading glass) for preventing adhesion of minute foreign matter such as paper dust. The reading glass is arranged adjacent to a bottom plate provided on the light irradiation side of the image sensor. The white reference plate is attached to the reading glass.

The bottom plate of the image sensor is mainly formed of resin or metal, and is slightly deformed due to an influence of a temperature inside the printing machine. The deformation of the bottom plate may cause a change in a position of the reading glass fixed to the bottom plate. This leads to a difference between the first distance and the second distance, and hence it becomes difficult to perform the shading correction with high accuracy. This may cause deterioration in image quality of the reading result (read image) obtained by the image reading apparatus.

### SUMMARY

An image reading apparatus according to one embodiment of the present disclosure includes a conveyance portion configured to convey a sheet on which an image has been formed, a reading unit configured to read the image formed on the sheet being conveyed by the conveyance portion, a transparent member provided between the reading unit and a position at which the conveyance portion conveys the sheet, a reference member, which is provided to the transparent member, and is to be read by the reading unit, support members configured to support the transparent member at both ends in a direction intersecting a conveyance direction of the sheet being conveyed by the conveyance portion, and a moving portion configured to move the support members.

An image forming system according to another embodiment includes a conveyance portion configured to convey a sheet, an image forming portion configured to form an image on the sheet being conveyed by the conveyance portion, and an image reading apparatus configured to read the sheet on which the image has been formed by the image forming portion, wherein the image reading apparatus includes a reading unit configured to read the image formed on the sheet being conveyed by the conveyance portion, a reference member to be read by the reading unit at a time of performing shading correction, a transparent member, which is provided between the reading unit and a position at which the conveyance portion conveys the sheet, prevents foreign matter from adhering to the reading unit, and has the reference member attached to the transparent member, support members configured to support the transparent member at both ends in a direction intersecting a conveyance direction of the sheet being conveyed by the conveyance portion, and a moving portion configured to move the support members.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration view of an inkjet recording apparatus

FIG. 2 is a configuration view of a print module.

FIGS. 3A and 3B are explanatory views of an in-line scanner unit.

FIG. 4 is a view of an inner box viewed from an image formation surface side.

FIGS. 5A and 5B are operation explanatory views of the in-line scanner unit.

FIG. 6 is a cross-sectional view of the in-line scanner unit.

FIG. 7 is an explanatory diagram of a control board.

FIGS. 8A, 8B, and 8C are explanatory views of a glass moving portion.

FIG. 9 is an explanatory view of a holding structure of the glass moving portion.

### DESCRIPTION OF THE EMBODIMENTS

Now, referring to the accompanying drawings, description is given of at least one exemplary embodiment of the present disclosure.

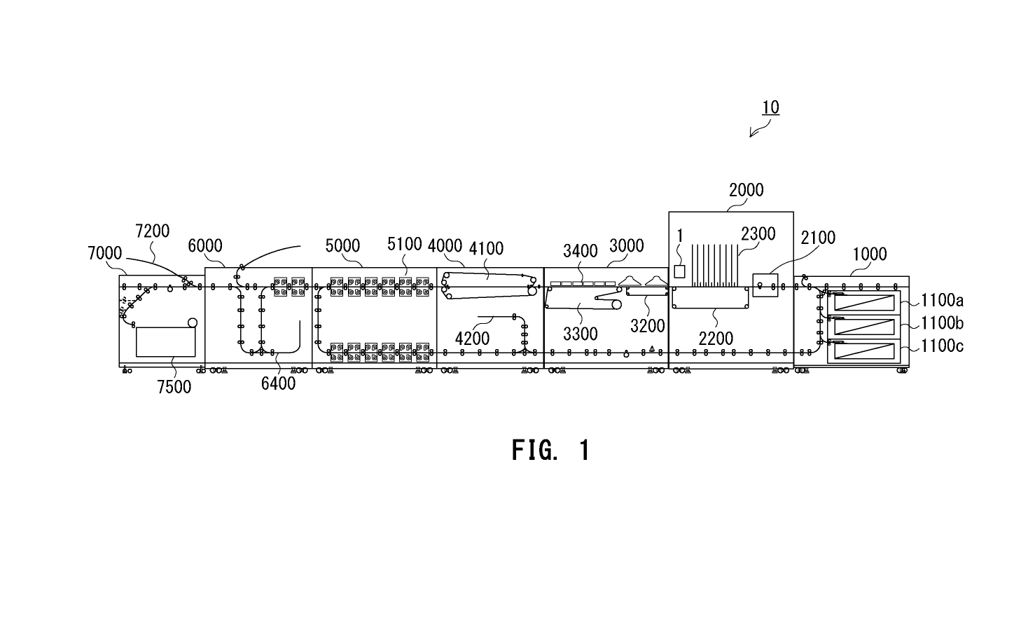

FIG. 1 is a configuration view of an inkjet recording apparatus which is an image forming system according to the at least one embodiment. This inkjet recording apparatus 10 is, for example, a printing machine to be used in a commercial printing field or an industrial printing field. The inkjet recording apparatus 10 forms an image by ejecting ink onto a sheet, which is a cut-sheet-shaped recording material. The inkjet recording apparatus 10 according to the at least one embodiment generates a printed product by forming an ink image on a sheet through use of two liquids which are a reaction liquid and ink. The sheet may be a material that is suitable for use with ink, for example, plain paper, thick paper, a plastic film for an overhead projector, a special-shaped sheet such as an envelope or index paper, or cloth.

The inkjet recording apparatus 10 includes a sheet feeding module 1000, a print module 2000, a drying module 3000, a fixing module 4000, a cooling module 5000, a reversing module 6000, and a delivery stacking module 7000. A sheet is fed from the sheet feeding module 1000, receives predetermined processing relating to image formation at each module, and is delivered to the delivery stacking module 7000. In the inkjet recording apparatus 10 according to the at least one embodiment, the respective modules each have a separate casing, and the casings are coupled to each other. The inkjet recording apparatus 10 may also include the functions of the respective modules within a single casing.

The sheet feeding module 1000 includes a plurality of (in the at least one embodiment, three tiers of) sheet storage portions 1100a to 1100c. The sheet storage portions 1100a to 1100c can each store sheets. The sheet storage portions 1100a to 1100c are configured such that each sheet storage portion can be pulled out to a front side of the apparatus. The sheet storage portions 1100a to 1100c are pulled out to the front side of the apparatus to receive sheets. The sheet feeding module 1000 feeds sheets one by one to the print module 2000. Accordingly, the sheet storage portions 1100a to 1100c are each provided with a separation belt and a conveyance roller. The number of the sheet storage portions 1100a to 1100c is an example, and a single tier of sheet storage portion, or two, or four or more, tiers of sheet storage portions may be provided.

The print module 2000 functions as an image forming apparatus that forms an image on the sheet fed from the sheet feeding module 1000. The print module 2000 includes a pre-image-forming registration correction portion 2100, a print belt unit 2200, and a recording portion 2300. The pre-image-forming registration correction portion 2100 corrects a tilt and a position of the sheet fed from the sheet feeding module 1000, and conveys the corrected sheet to the print belt unit 2200.

The print belt unit 2200 and the recording portion 2300 are arranged so as to face each other across a conveyance path of the sheet, on a downstream side of the pre-image-forming registration correction portion 2100 in a conveyance direction of the sheet. The print belt unit 2200 conveys, by suction, the sheet conveyed from the pre-image-forming registration correction portion 2100. The recording portion 2300 is a sheet processing portion that forms an image on the sheet conveyed from the print belt unit 2200 by performing, from above the sheet, recording processing (printing) with a recording head. The recording head executes printing by ejecting ink onto the sheet. A clearance between the recording head and the sheet is kept constant through conveyance of the sheet by way of suction by the print belt unit 2200.

A plurality of recording heads are arranged side by side along the conveyance direction of the sheet. The recording heads in the at least one embodiment are five line-type recording heads corresponding to four colors of yellow (Y), magenta (M), cyan (C), and black (K) as well as a reaction liquid. The number of colors and the number of recording heads are not limited to five. Examples of an adoptable inkjet method include a method that uses a heating element, a method that uses a piezo element, a method that uses an electrostatic element, and a method that uses a micro-electromechanical systems (MEMS) element. Ink of each color is supplied to the corresponding recording head via an ink tube from an ink tank (not shown). The ink contains, for example, 0.1% by mass to 20.0% by mass of a resin component based on the total mass, water, a water-soluble organic solvent, a colorant, wax, and additives.

The sheet on which printing has been executed by the recording portion 2300 is conveyed by the print belt unit 2200. An in-line scanner unit 1 is placed on a downstream side of the recording portion 2300 in the conveyance direction. The in-line scanner unit 1 is an image reading apparatus which is used to correct a printed image by detecting positional misalignment and color densities of the image formed on the sheet.

For example, coordinates of a mark formed on an edge of the sheet and coordinates of the four corners of the sheet are detected from a reading result (read image) of the sheet obtained by the in-line scanner unit 1. Those detection results are used to adjust geometric characteristics such as the right angles and skew of the image, leading-edge registration, left registration, a main magnification, and a sub-magnification, to thereby correct image misalignment. Further, pixel values (brightness values) of an image for adjustment of the densities of the image formed on the sheet are analyzed from the reading result (read image) of the sheet obtained by the in-line scanner unit 1. An ejection amount of the ink from the recording head is adjusted based on the analysis result, to thereby correct the color densities.

The drying module 3000 dries the sheet on which the image has been formed by the print module 2000 by blowing hot air onto the sheet. The drying module 3000 reduces a liquid constituent contained in the ink by drying the sheet, to thereby improve fixability of the ink to the sheet. The drying module 3000 includes a decoupling portion 3200, a drying belt unit 3300, and a hot air blowing portion 3400.

The sheet on which printing has been executed by the recording portion 2300 of the print module 2000 is conveyed to the decoupling portion 3200 inside the drying module 3000. The decoupling portion 3200 conveys the sheet by lightly holding the sheet with a frictional force produced between the sheet and a belt by the pressure of air blown from above. This prevents misalignment of a part of the sheet that remains on the print belt unit 2200 when the sheet lies partially on the decoupling portion 3200 and the rest of the sheet is on the print belt unit 2200.

The sheet conveyed from the decoupling portion 3200 is conveyed by suction by the drying belt unit 3300, and hot air is concurrently blown onto the sheet from the hot air blowing portion 3400 placed above the belt, to thereby dry an ink applied surface (image printed surface). The ink and the reaction liquid applied to the sheet are heated to promote evaporation of moisture, thereby causing the sheet to absorb the applied ink, and hence occurrence of so-called cockling in which local expansion of the sheet causes wrinkles can be suppressed. For example, an electric heating wire or an infrared heater is preferred as a heater for heating air from the viewpoints of safety and energy efficiency. The drying method may be, in addition to the method to blow the hot air, a method of irradiating a sheet surface with an electromagnetic wave (an ultraviolet ray, an infrared ray, or the like), a conductive heat transfer method by contact with a heat generator, or any combination of these methods.

The fixing module 4000 fixes the image to the sheet by heating the sheet that has been dried by the drying module 3000, and thus drying the ink. The fixing module 4000 includes a fixing belt unit 4100 which includes an upper belt unit and a lower belt unit. The fixing module 4000 passes the sheet that has been conveyed from the drying module 3000 between the upper belt unit and the lower belt unit which have each been heated, to thereby sufficiently cause the ink solvent to permeate the sheet (fix the ink solvent to the sheet).

The cooling module 5000 cools the sheet to which the image has been fixed by the fixing module 4000, to thereby solidify the ink softened from heating, and, at the same time, suppress a temperature change caused in the sheet by a downstream apparatus. The cooling module 5000 includes a plurality of cooling portions 5100. The plurality of cooling portions 5100 cool the high-temperature sheet conveyed from the fixing module 4000. The cooling portions 5100 each raise a pressure in a cooling box by taking outside air into the cooling box through use of a fan. The air in the cooling box is blown out of a nozzle formed in the conveyance path as an airflow directed to the sheet, and cools the sheet. The plurality of cooling portions 5100 are arranged on each side of the conveyance path so that the sheet can be cooled from both sides.

A conveyance path switching portion is provided in the cooling module 5000. The conveyance path switching portion switches the conveyance path of the sheet between a path on which the sheet is to be conveyed to the reversing module 6000 and a duplex-printing conveyance path to be used in duplex printing.

In duplex printing, the sheet is conveyed to the conveyance path in a lower part of the cooling module 5000, and then is conveyed through the duplex-printing conveyance path of the fixing module 4000, the drying module 3000, the print module 2000, and the sheet feeding module 1000. A duplex-printing portion of the fixing module 4000 is provided with a first reversing portion 4200 for reversing a front surface and a back surface of the sheet. The sheet is conveyed to the first reversing portion 4200 once, and then reversed and conveyed to the drying module 3000 side, and the image printing surface is thus reversed. The stop at the first reversing portion 4200 enables printing on the back surface of the sheet. After that, the sheet is again conveyed to the pre-image-forming registration correction portion 2100, the print belt unit 2200, and the recording portion 2300 of the print module 2000 to be printed on.

The reversing module 6000 includes a second reversing portion 6400. The reversing module 6000 can use the second reversing portion 6400 to reverse the front surface and the back surface of the sheet being conveyed. The orientation of the front surface and the back surface of a sheet that is about to be delivered can thus be changed. The delivery stacking module 7000 includes a top tray 7200 and a stacking tray 7500. The delivery stacking module 7000 stacks, in an orderly manner, sheets conveyed from the reversing module 6000 on the top tray 7200 or the stacking tray 7500.

### Print Module

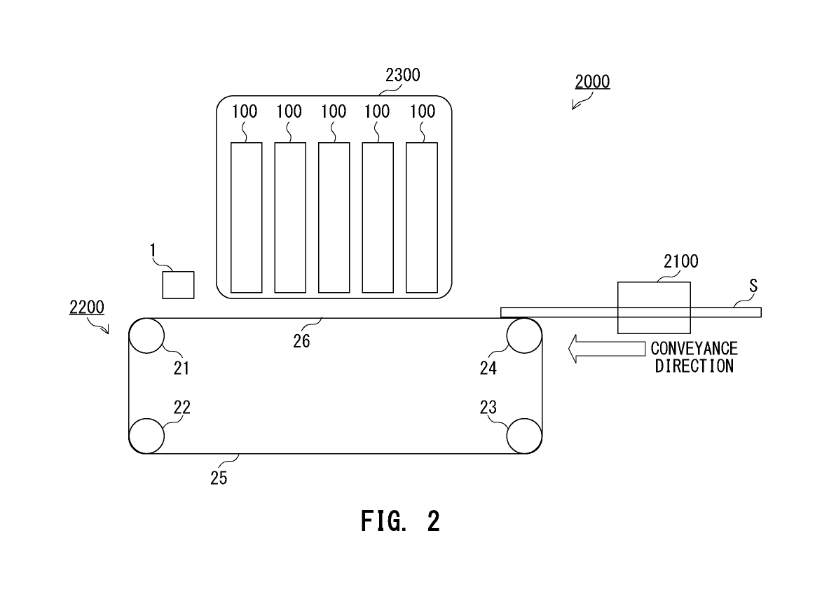

FIG. 2 is a configuration view of the print module 2000. As described above, the print module 2000 includes the pre-image-forming registration correction portion 2100, the print belt unit 2200, and the recording portion 2300. A sheet S having an orientation adjusted by the pre-image-forming registration correction portion 2100 is printed by the recording portion 2300 directly below a recording head 100. The sheet S is attracted through suction by the print belt unit 2200 and conveyed, thereby stabilizing the conveyance behavior directly below the recording head 100.

The print belt unit 2200 includes an endless print belt 25 stretched by stretch rollers 21, 22, 23, and 24. A belt surface of the print belt 25 stretched by the stretch roller 21 and the stretch roller 24 serves as an image formation surface 26 on which image formation is to be performed directly below the recording head 100. The print belt 25 rotates so that the image formation surface 26 moves in the conveyance direction of the sheet S. The print belt 25 has a large number of suction holes (not shown) for suction with respect to the sheet S.

The print belt 25 attracts the sheet S through suction by the suction holes positioned in the image formation surface 26 and rotates to convey the attracted sheet S. That is, the image formation surface 26 also serves as a conveyance surface for conveying the sheet S. The print belt 25 also functions as a conveyance portion that carries and conveys the sheet S on which an image has been formed. For that purpose, a suction device (not shown) for attracting the sheet S through suction onto the suction holes in the image formation surface 26 is provided at a position surrounded by the print belt 25. The print belt 25 is produced, for example, by forming the suction holes in a single strip-shaped PET sheet wound in a roll, cutting the sheet into a predetermined length, and then joining end portions thereof to each other by laser welding.

The sheet S attracted onto the image formation surface 26 is conveyed with a print gap of a predetermined distance provided between the sheet S and the recording head 100. As described above, as the recording heads 100, five line-type recording heads corresponding to four colors of yellow (Y), magenta (M), cyan (C), and black (K) as well as the reaction liquid are arranged along the conveyance direction of the sheet S. The number of recording heads 100 is not limited to five, and there may be employed, for example, eight line-type recording heads including recording heads corresponding to three spot colors in addition to the above-mentioned recording heads. The in-line scanner unit 1 is arranged on the downstream side of the recording head 100 in the conveyance direction of the sheet S.

### In-line Scanner Unit

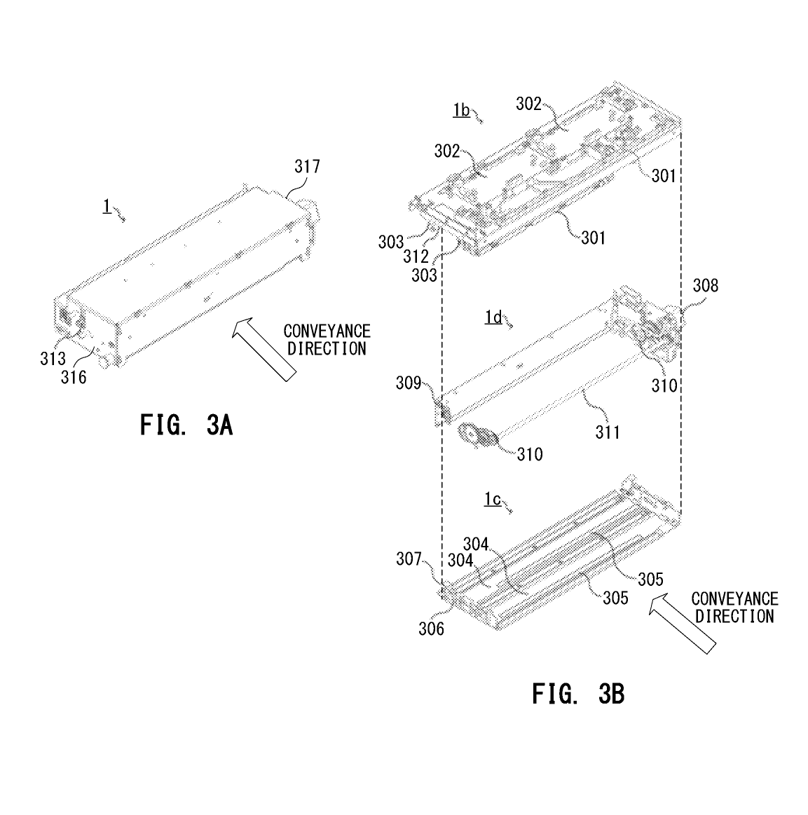

FIGS. 3A and 3B are explanatory views of the in-line scanner unit 1. FIG. 3A is an external perspective view of the in-line scanner unit 1. FIG. 3B is an exploded view of the in-line scanner unit 1. The in-line scanner unit 1 includes an inner box 1b, an outer box 1d, and a glass moving portion 1c.

The in-line scanner unit 1 is provided with an inner box movement restricting member 313 on a front side plate 316. The inner box movement restricting member 313 restricts movements of the inner box 1b in the horizontal direction. The horizontal direction is a direction parallel to the image formation surface 26. The in-line scanner unit 1 is arranged in the print module 2000 so that the inner box movement restricting member 313 (front side plate 316) faces the front side of FIG. 2 and a back side plate 317 faces the back side of FIG. 2.

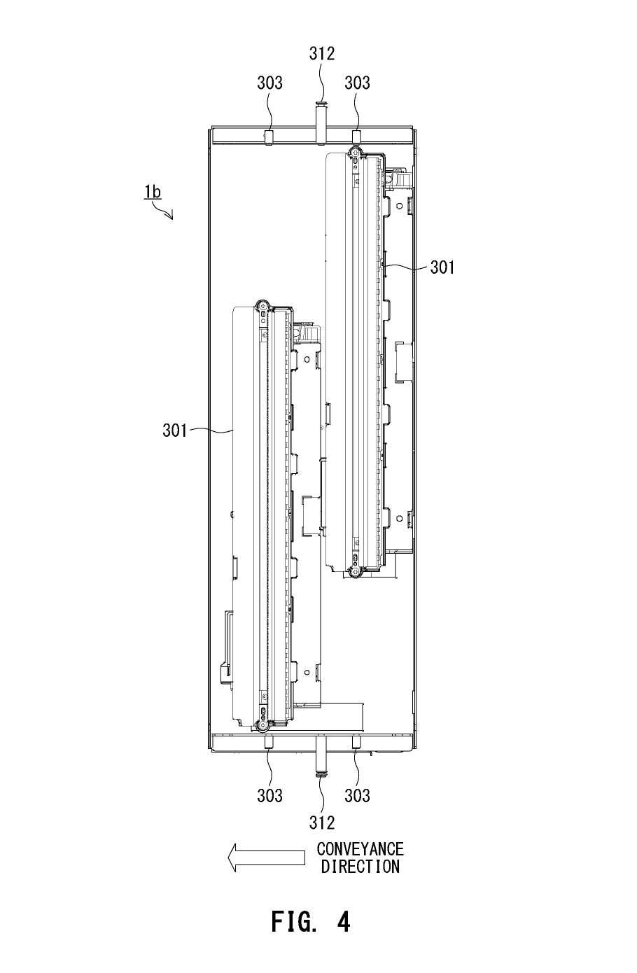

Two reading units 301 which are image sensors for optically reading an image are attached to the inner box 1b. FIG. 4 is a view of the inner box 1b viewed from the image formation surface 26 side. The two reading units 301 are arranged side by side in a direction intersecting the conveyance direction of the sheet S. The two reading units 301 are located at different positions in the conveyance direction. This arrangement enables the two reading units 301 to read the entire area in the direction intersecting the conveyance direction of the sheet S. The inner box 1b is provided with two control boards 302 for controlling the two reading units 301. There is a one-to-one correspondence between the two reading units 301 and the two control boards 302.

The inner box 1b is provided with two inner box short shafts 303 and an inner box long shaft 312. At the time of shading correction, the inner box 1b moves in upward and downward directions due to the two inner box short shafts 303. The upward direction is a direction away from the image formation surface 26, and the downward direction is a direction toward the image formation surface 26. The inner box long shaft 312 restricts movements of the inner box 1b in the conveyance direction (leftward and rightward directions). The leftward direction is the downstream side in the conveyance direction of the sheet S, and the rightward direction is the upstream side in the conveyance direction of the sheet S. The inner box long shaft 312 fits with the inner box movement restricting member 313 of the casing. The inner box long shaft 312 is thereby configured to allow the inner box 1b to move in the upward and downward directions but restrict the movement thereof in the leftward and rightward directions.

The outer box 1d is provided with a motor 308, a photosensor 309, two cams 310, and a shaft 311. The two cams 310 are provided at both ends (on the front side and the back side) in the direction intersecting the conveyance direction of the sheet S. Glass moving members 306 described later abut against peripheral surfaces (surfaces parallel to the axial direction of the rotation shaft) of the two cams 310. For that reason, when the motor 308 is driven to rotate the two cams 310, the glass moving members 306 move by being pushed by the cams 310. A drive force of the motor 308 is transmitted to the cam 310 on the front side through the shaft 311. The photosensor 309 is used to detect the position of the glass moving portion 1c when a light-transmitting state and a light-blocking state are switched by a flag 307 provided to the glass moving portion 1c.

The glass moving portion 1c is provided with two reading glasses 304 corresponding to the two reading units 301, the flag 307, and the glass moving members 306 that support the inner box short shafts 303. A white reference plate 305 that is a white reference member for performing the shading correction is attached to each of the two reading glasses 304. The two reading glasses 304 each function as a transparent member that transmits light reflected from an object to be read. The two reading glasses 304 are attached to the glass moving members 306. At the time of the shading correction, the entire glass moving portion 1c including the white reference plate 305 moves in the leftward direction (to the downstream side in the conveyance direction of the sheet S).

The two reading glasses 304 are provided between the corresponding reading units 301 and the print belt 25 (image formation surface 26), and have a dust-proof function of preventing foreign matter from adhering to the reading units 301.

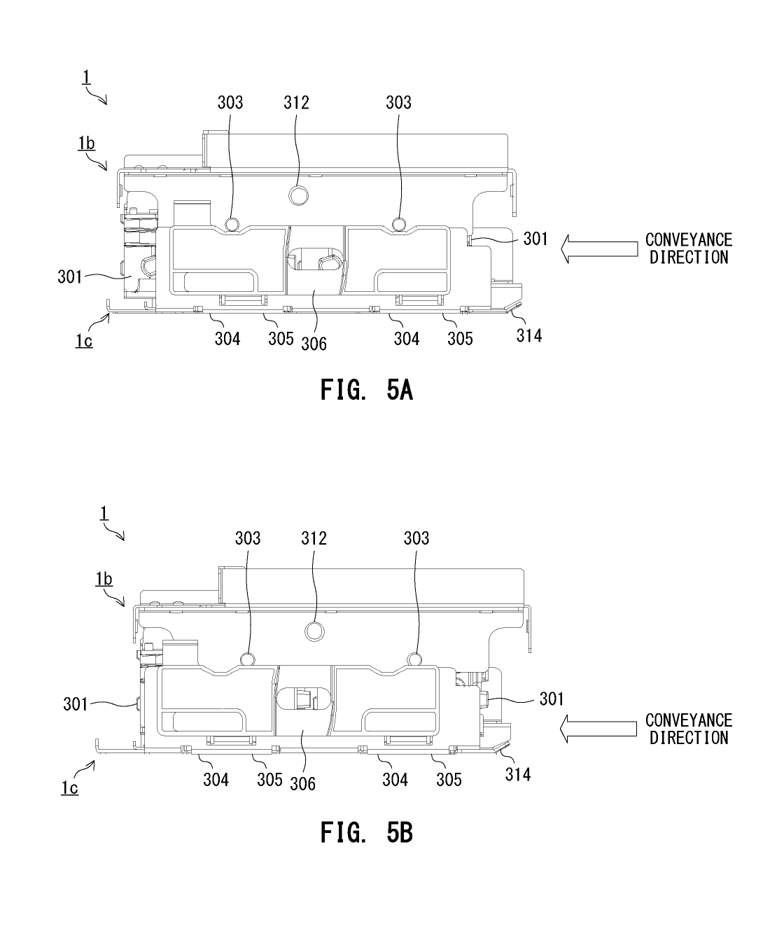

FIGS. 5A and 5B are operation explanatory views of the in-line scanner unit 1 at the time of the shading correction. At the time of the shading correction, the entire glass moving portion 1c including the white reference plate 305 moves from the position illustrated in FIG. 5A to the downstream position in the conveyance direction illustrated in FIG. 5B. The movement of the entire glass moving portion 1c causes the inner box short shafts 303 to ride up from the bottom onto the top of a step of each of the glass moving members 306. This causes the glass moving portion 1c to be pushed by the inner box short shafts 303 of the inner box 1b to move toward the image formation surface 26 side. That is, the glass moving portion 1c moves to the lower left in FIG. 5B.

When the glass moving portion 1c has been moved toward the image formation surface 26 side by the inner box 1b, the white reference plate 305 is positioned at the same height in a height direction as the surface of the sheet on the image formation surface 26. A distance of the inner box 1b from the image formation surface 26 has not changed, and hence a distance from the reading unit 301 to the image formation surface 26 also has not changed. This enables the reading unit 301 to read the white reference plate 305 at the same distance as a distance from the reading unit 301 to the surface of the sheet S exhibited at the time of reading the sheet S. Therefore, it is possible to achieve the shading correction with high accuracy. At the time of the shading correction, the white reference plate 305 moves to the same position as a position of the sheet S at which the image on the sheet S is to be read, and in a case where the image on the sheet S is to be read, moves to another position.

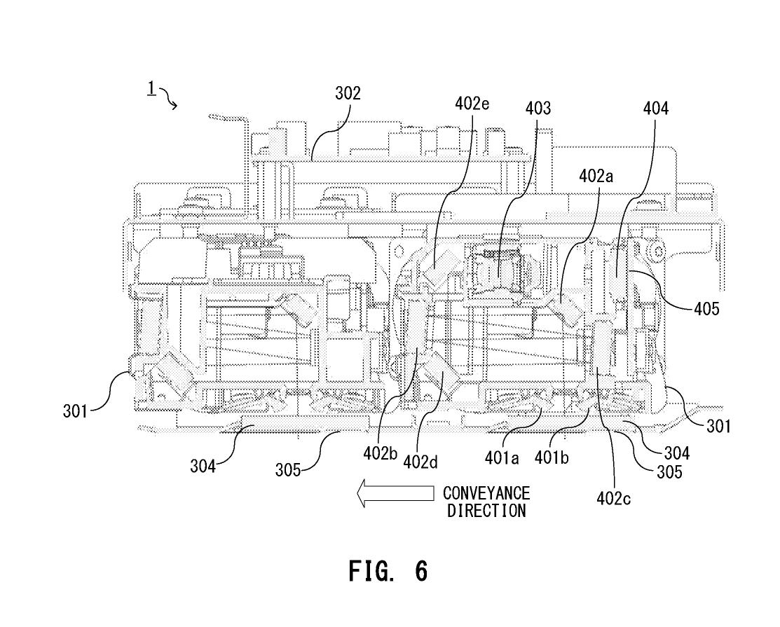

FIG. 6 is a cross-sectional view of the in-line scanner unit 1. This cross-sectional view is an illustration of a cross section of the in-line scanner unit 1 cut in the conveyance direction of the sheet S. The reading unit 301 includes light sources 401a and 401b, reflecting mirrors 402a, 402b, 402c, 402d, and 402e, an imaging lens 403, a light-receiving portion 404, and a sensor substrate 405. The light sources 401a and 401b irradiate the sheet S on the image formation surface 26 with light. The light sources 401a and 401b are configured by arranging a plurality of light-emitting elements, for example, light emitting diodes (LEDs), in a line in the direction intersecting the conveyance direction. The light-receiving portion 404 receives light reflected by the sheet S of the light emitted from the light sources 401a and 401b. The reflecting mirrors 402a to 402e form an optical system that guides the light reflected by the sheet S to the imaging lens 403. The imaging lens 403 causes an image of the reflected light guided by the reflecting mirrors 402a to 402e to be formed on the light-receiving surface of the light-receiving portion 404.

The light-receiving portion 404 outputs a reading result (read image) that is an electrical signal corresponding to the reflected light received on the light-receiving surface. This reading result is an analog signal representing the image read from the sheet S. The light-receiving portion 404 is configured by arranging a plurality of photoelectric conversion elements, for example, charge coupled device (CCD) sensors, in the same direction as that of the line of light-emitting elements. The light-receiving portion 404 is mounted on the sensor substrate 405. The sensor substrate 405 is connected to the control board 302, and transmits the reading result (read image), which is the analog signal output from the light-receiving portion 404, to the control board 302. A configuration of the control board 302 is described later.

The reading unit 301 reads an image with a main scanning direction being set to the direction in which each of the line of the light-emitting elements of the light sources 401a and 401b and the line of the photoelectric conversion elements of the light-receiving portion 404 extends. The main scanning direction is, for example, the direction intersecting the conveyance direction of the sheet S. The conveyance direction of the print belt 25 intersecting the main scanning direction is set as a sub-scanning direction. The reading unit 301 reads an image on the sheet S being conveyed along the conveyance direction.

The white reference plate 305 provided on the reading glass 304 is read by the reading unit 301 at the time of the shading correction. The light-receiving portion 404 has individual differences in characteristics among respective photoelectric conversion elements (respective pixels). In addition, it is not easy to cause light emitted from the light sources 401a and 401b to become uniform in the main scanning direction. For those reasons, even when the sheet S on which an image having a uniform image density is formed is used to read the image therefrom, there is a possibility that image data, which is the reading result, may vary for each position in the main scanning direction.

In order to suppress such variation, the shading correction is performed. Specifically, the reading unit 301 reads the white reference plate 305. From the reading result of the white reference plate 305, such a correction value as to cause the reading result (e.g., brightness values) of the respective pixels in the main scanning direction to become uniform at a specific value is derived. This correction value is used to correct the irradiation amount of the light sources 401a and 401b, sensitivity variation of the photoelectric conversion elements of the light-receiving portion 404, or the reading result of the image on the sheet S, thereby correcting the individual differences among the photoelectric conversion elements and the variation in the light amount.

As described with reference to FIGS. 5A and 5B, the distance from the reading unit 301 to the white reference plate 305 exhibited at the time of reading the white reference plate 305 is the same as the distance from the reading unit 301 to the sheet S exhibited at the time of reading the sheet S. Such a distance from the reading unit 301 to the object to be read (the white reference plate 305 or the sheet S) is hereinafter referred to as "reading height." The variation in the light distribution of the light sources 401a and 401b in the main scanning direction differs depending on the reading height as well, and hence when the reading height differs between the time of the shading correction and the time of reading the sheet S, there is a fear that appropriate shading correction may fail to be performed, resulting in deterioration in image quality of the read image. In the at least one embodiment, the reading height is the same between the time of the shading correction and the time of reading the sheet S, and hence it is possible to achieve appropriate shading correction.

### Control Board

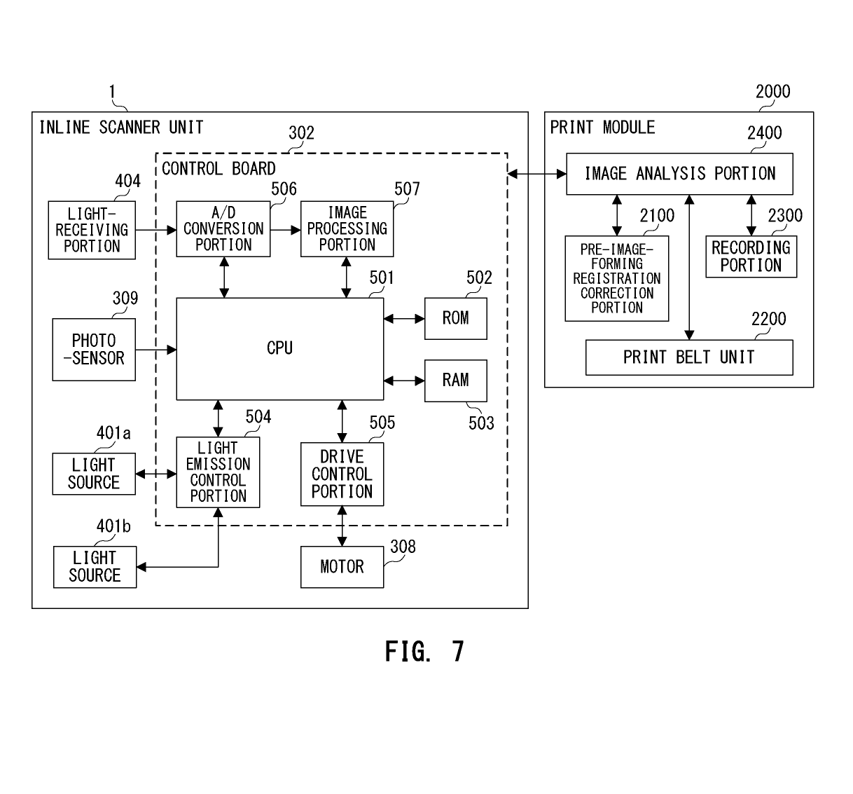

FIG. 7 is an explanatory diagram of the control board 302. The control board 302 is electrically connected to the light sources 401a and 401b and the light-receiving portion 404 of the reading unit 301. The control board 302 is further electrically connected to the motor 308 and the photosensor 309. As described above, the motor 308 is a drive source for moving the glass moving portion 1c on which the white reference plate 305 is provided. In FIG. 7, the in-line scanner unit 1 is connected to the print module 2000.

The control board 302 is an information processing device including a central processing unit (CPU) 501, a read only memory (ROM) 502, and a random access memory (RAM) 503. The CPU 501 executes a computer program stored in the ROM 502 with the RAM 503 being used as a work area, to thereby control operation of the in-line scanner unit 1. In addition, the control board 302 includes a light emission control portion 504 for controlling operation of the light sources 401a and 401b, a drive control portion 505 for controlling operation of the motor 308, an A/D conversion portion 506 for processing the reading result (read image), and an image processing portion 507. The light emission control portion 504, the drive control portion 505, the A/D conversion portion 506, and the image processing portion 507 are connected to the CPU 501. The control board 302 may be implemented by a discrete product or a one-chip semiconductor product. Examples of the one-chip semiconductor product include a micro-processing unit (MPU), an application specific integrated circuit (ASIC), and a system-on-a-chip (SOC).

The light emission control portion 504 is controlled by the CPU 501 to control operation for turning on and off the light sources 401a and 401b. The drive control portion 505 is controlled by the CPU 501 to transmit a drive signal to the motor 308, to thereby control operation for moving the glass moving portion 1c. Specifically, the drive control portion 505 controls the movement of the glass moving portion 1c so as to bring the glass moving portion 1c to the state illustrated in FIG. 5A at the time of reading the sheet S, and controls the movement of the glass moving portion 1c so as to bring the glass moving portion 1c to the state illustrated in FIG. 5B at the time of reading the white reference plate 305.

The A/D conversion portion 506 is controlled by the CPU 501 to convert the reading result (read image), which is the analog signal output from the light-receiving portion 404, into a digital signal and transmit the digital signal to the image processing portion 507. The image processing portion 507 is controlled by the CPU 501 to perform various types of image processing on the reading result (read image), which is the digital signal acquired from the A/D conversion portion 506, to generate image data representing the image read from the sheet S. The image data is transmitted from the control board 302 to the print module 2000 or an external apparatus such as a personal computer.

The print module 2000 includes an image analysis portion 2400. The image analysis portion 2400 analyzes the image data acquired from the control board 302 to calculate various correction values. The correction values calculated by the image analysis portion 2400 are fed back to the pre-image-forming registration correction portion 2100, the print belt unit 2200, and the recording portion 2300 to be used to adjust geometric characteristics and image density unevenness.

### Holding of Reading Glass

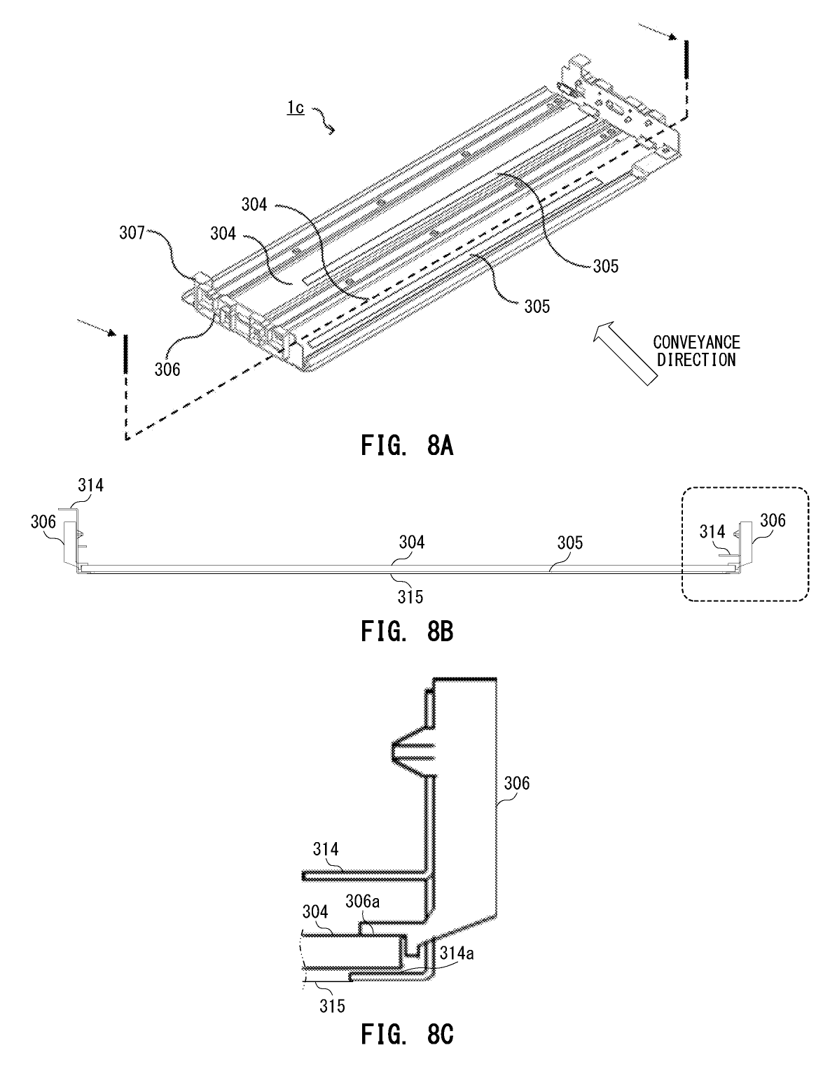

A holding structure of the reading glass 304 is described. FIGS. 8A, 8B, and 8C are explanatory views of the glass moving portion 1c. FIG. 8A is an overall perspective view of the glass moving portion 1c. FIG. 8B is a cross-sectional view of the glass moving portion 1c taken along the dotted line of FIG. 8A. FIG. 8C is an enlarged view of a portion surrounded by the dotted line of FIG. 8B.

The reading glass 304 on which the white reference plate 305 is provided is supported at both ends in the main scanning direction by support members 314. The support members 314 are provided to the glass moving members 306. The support members 314 and the glass moving members 306 both have surfaces (parallel surfaces 314a and parallel surfaces 306a) that are parallel to the image formation surface 26.

Both ends of the reading glass 304 in a longitudinal direction (main scanning direction) are supported by the parallel surfaces 314a and the parallel surfaces 306a of the support members 314. Specifically, a surface of the reading glass 304 on the image formation surface 26 side is supported by the parallel surfaces 314a of the support members 314, and a surface of the reading glass 304 on the reading unit 301 side is in contact with the parallel surfaces 306a of the glass moving members 306. That is, both ends of the reading glass 304 in the longitudinal direction (main scanning direction) are sandwiched between the parallel surfaces 314a of the support members 314 and the parallel surfaces 306a of the glass moving members 306. With such a configuration, the glass moving members 306 can prevent the reading glass 304 from falling off the glass moving portion 1c.

A sheet passing guide 315 is provided on the image formation surface 26 side of the reading glass 304. The sheet passing guide 315 is fixed to the support members 314 through use of a fixing member such as a double-sided tape. The sheet S is attracted onto the image formation surface 26 and conveyed between the sheet passing guide 315 and the image formation surface 26.

As illustrated in FIG. 8B, the reading glass 304 is configured to be adjacent to the sheet passing guide 315 through the support members 314. However, as illustrated in FIG. 8C, the reading glass 304 is not in contact with the support members 314 in a region other than both ends in the main scanning direction. For that reason, the reading glass 304 is separate from the sheet passing guide 315.

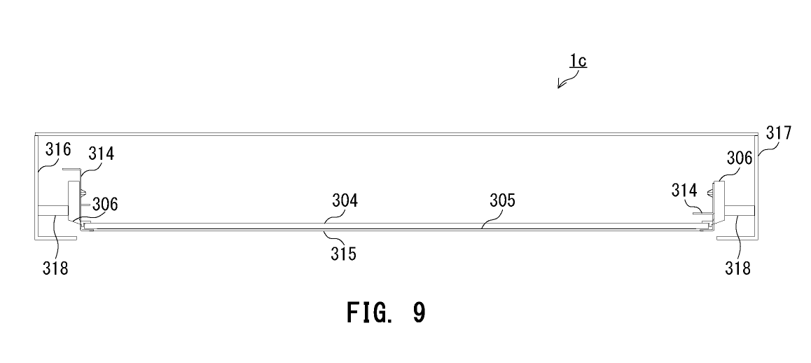

FIG. 9 is an explanatory view of a holding structure of the glass moving portion 1c. The glass moving portion 1c is configured such that the glass moving members 306 provided at both ends in the main scanning direction are held by slide shafts 318 attached to the front side plate 316 and the back side plate 317. The front side plate 316 and the back side plate 317 form a casing of the glass moving portion 1c. The casing of the glass moving portion 1c is formed in a shape that is open on the sheet passing guide 315 side so that the sheet passing guide 315 is exposed.

The support members 314 and the glass moving members 306 are usually formed of mainly resin or metal. Therefore, the support members 314 and the glass moving members 306 are slightly deformed due to an influence of an in-machine temperature. Now, a configuration in which both ends of the reading glass 304 in a short-side direction are supported by metal plates is assumed. Those metal plates are each arranged along the longitudinal direction of the reading glass 304. However, in the configuration in which both ends of the reading glass 304 in the short-side direction are supported by the metal plates, the metal plates are deformed into a bow shape due to an influence of the in-machine temperature. When the metal plates supporting the reading glass 304 are deformed into a bow shape, the reading glass 304 is brought to a state of resting on the metal plates in abutment therewith at points or lines. This causes a change in an orientation of the reading glass 304 resting on the metal plates. According to experiments, it has been found that, in a case where each of the metal plates has a length of 500 mm in the longitudinal direction, heights of both ends of the reading glass 304 in the longitudinal direction change by as much as 0.2 mm. However, the support members 314 and the glass moving members 306 described in the at least one embodiment only support both ends of the reading glass 304 in the main scanning direction. Therefore, even when the support members 314 and the glass moving members 306 are deformed, physical influences thereof on the reading glass 304 are small. According to experiments, the heights of both ends of the reading glass 304 in the longitudinal direction changed by less than 0.1 mm.

For that reason, the distance to the sheet S exhibited in a case where the reading unit 301 reads the sheet S and the distance to the white reference plate 305 exhibited in a case where the reading unit 301 reads the white reference plate 305 are the same without changing due to the influences of the support members 314 and the glass moving members 306. As a result, even when the support members 314 and the glass moving members 306 are slightly deformed by heat, the shading correction can be performed with high accuracy. Therefore, deterioration in the image quality of the reading result (read image) obtained by the in-line scanner unit 1 is suppressed.

In the at least one embodiment, an example in which the in-line scanner unit 1 is provided in the print module 2000 of the inkjet method has been described. The in-line scanner unit 1 in the at least one embodiment is also effective in a case where the in-line scanner unit 1 is provided to other apparatus such as an electrophotographic image forming system. In any case, the in-line scanner unit 1 may be installed in any apparatus as long as the in-line scanner unit 1 is configured to perform the shading correction by reading the white reference plate 305 at the same position as the position at which the sheet S is to be read.

As described above, according to the present disclosure, it is possible to suppress deterioration in accuracy of the shading correction.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-188267, filed October 25, 2024, which is hereby incorporated by reference herein in its entirety.

What is claimed is:

1. An image reading apparatus comprising:
a conveyance portion configured to convey a sheet on which an image has been formed;
a reading unit configured to read the image formed on the sheet being conveyed by the conveyance portion;
a transparent member provided between the reading unit and a position at which the conveyance portion conveys the sheet;
a reference member, which is provided to the transparent member, and is to be read by the reading unit;
support members configured to support the transparent member at both ends in a direction intersecting a conveyance direction of the sheet being conveyed by the conveyance portion; and
a moving portion configured to move the support members.

2. The image reading apparatus according to claim 1,
wherein the moving portion is configured to:
move, in a case where the reading unit is to execute control to read the reference member, the support members so as to move the reference member attached to the transparent member to a first position; and
move, in a case where the reading unit is to execute control to read the image formed on the sheet, the support members so as to move the reference member attached to the transparent member from the first position to a second position which is different from the first position, and
wherein the conveyance portion is configured to convey, in a case where the control to read the image formed on the sheet is to be executed, the sheet to the first position.

3. The image reading apparatus according to claim 2, wherein the moving portion is configured to move, in a case where the reading unit is to read the image formed on the sheet, the support members from the first position in the conveyance direction, to thereby move the reference member attached to the transparent member to the second position.

4. The image reading apparatus according to claim 3,
wherein the conveyance portion is configured to convey the sheet by attracting the sheet onto a surface of a belt, and
wherein the support members have first parallel surfaces that are parallel to the surface of the belt onto which the sheet is to be attracted, and are configured to support the transparent member by the first parallel surfaces.

5. The image reading apparatus according to claim 4, further comprising moving members to which the support members are attached,
wherein the reference member attached to the transparent member supported by the support members moved by the moving members being moved by the moving portion.

6. The image reading apparatus according to claim 5, wherein the moving members have second parallel surfaces that are parallel to the surface of the belt onto which the sheet is to be attracted, and are configured to hold down the transparent member by the second parallel surfaces.

7. The image reading apparatus according to claim 6, wherein the support members are provided with a sheet passing guide on a side that faces the surface of the belt onto which the sheet is to be attracted, the side being opposite to the transparent member side.

8. An image forming system comprising:
a conveyance portion configured to convey a sheet;
an image forming portion configured to form an image on the sheet being conveyed by the conveyance portion; and
an image reading apparatus configured to read the sheet on which the image has been formed by the image forming portion,
wherein the image reading apparatus includes:
a reading unit configured to read the image formed on the sheet being conveyed by the conveyance portion;
a reference member to be read by the reading unit at a time of performing shading correction;
a transparent member, which is provided between the reading unit and a position at which the conveyance portion conveys the sheet, prevents foreign matter from adhering to the reading unit, and has the reference member attached to the transparent member;
support members configured to support the transparent member at both ends in a direction intersecting a conveyance direction of the sheet being conveyed by the conveyance portion; and
a moving portion configured to move the support members.

9. The image forming system according to claim 8,
wherein the moving portion is configured to:
move, in a case where the reading unit is to execute control to read the reference member, the support members so as to move the reference member attached to the transparent member to a first position; and
move, in a case where the reading unit is to execute control to read the image formed on the sheet, the support members so as to move the reference member attached to the transparent member from the first position to a second position which is different from the first position, and
wherein the conveyance portion is configured to convey, in a case where the control to read the image formed on the sheet is to be executed, the sheet to the first position.

10. The image forming system according to claim 9, wherein the moving portion is configured to move, in a case where the reading unit is to read the image formed on the sheet, the support members from the first position in the conveyance direction, to thereby move the reference member attached to the transparent member to the second position.

11. The image forming system according to claim 10,
wherein the conveyance portion is configured to convey the sheet by attracting the sheet onto a surface of a belt, and
wherein the support members have first parallel surfaces that are parallel to the surface of the belt onto which the sheet is to be attracted, and are configured to support the transparent member by the first parallel surfaces.

12. The image forming system according to claim 11, further comprising moving members to which the support members are attached,
wherein the reference member attached to the transparent member supported by the support members is moved by the moving members being moved by the moving portion.

13. The image forming system according to claim 12, wherein the moving members have second parallel surfaces that are parallel to the surface of the belt onto which the sheet is to be attracted, and are configured to hold down the transparent member by the second parallel surfaces.

14. The image forming system according to claim 13, wherein the support members are provided with a sheet passing guide on a side that faces the surface of the belt onto which the sheet is to be attracted, the side being opposite to the transparent member side.
